(19) United States
(12) Patent Application Publication
(10) Pub. No.: US 2015/0205088 A1
(43) Pub. Date: Jul. 23, 2015

(54) BEVEL-AXIAL AUTO-FOCUSING MICROSCOPIC SYSTEM AND METHOD THEREOF

(71) Applicant: U&U Engineering Inc., Taipei City (TW)

(72) Inventors: Ta-Ming SHIH, Hsinchu County (TW); Ho-Chung CHANG, Taichung City (TW); Ting-Wei CHI, Taipei City (TW); Hsiao-Yen CHUANG, Taipei City (TW)

(73) Assignee: U&U Engineering Inc., Taipei City (TW)

(21) Appl. No.: 14/162,107

(22) Filed: Jan. 23, 2014

(51) Int. Cl. G02B 21/24

(52) U.S. Cl. CPC G02B 21/241

(57) ABSTRACT

An embodiment disclosed bevel-axial auto-focusing method for a microscopic system, including: capturing full-frame bevel-axial input image; using image analysis to read image information and transmitting grayscale information to a statistic analysis module; the statistic module extracting image statistic characteristics and performing curve fitting with probability function; and estimating the optimal focus point based on the post-fitting characteristic parameters. A preferred embodiment combines image with Gaussian curve fitting and Kalman filter, and analyzes the in-focus position based on image quality so as to directly determine the optimal rectification value of the in-focus position on the object surface. The method can improve the accuracy and speed of auto-focusing.

### TECHNICAL FIELD

The technical field generally relates to a bevel-axial auto-focusing microscopic system and method thereof and, in particular, more related to a method able to calibrate to in-focus position in a single pass, which is combined with an estimation approach and robust to the external image noise interference in the environment, applicable to a microscopic optical system.

### BACKGROUND

Auto-focusing is an important technology for the automatic optical inspection application, and is mainly to use image processing to perform inspection to a target object. At present, auto-focusing technology is widely used in semiconductor element inspection, such as, semiconductor waffle, LCD panel, solar cells, circuit board inspection, and so on. Prior to applying image technology to feature determination, feature matching, and target positioning, an auto-focusing process must be executed.

In the development of electronic products, the yield rate depends heavily on the manufacturing process. High precision inspection technologies are required to improve the problems of defect parameters and product performance, and auto-focusing technology is the core to the inspection technologies.

Take TFT-LCD panel industry as an example. The color filter and the electrode array at the lower module end are prone to defects in a manufacturing process. To improve the yield rate, the auto-focusing technology is used in inspection to detect and position the defect, and then a laser micro-processing machine with auto-focusing capability to eliminate the defect. As such, the defect can be rectified to transform a defected product into a good product.

TFT-LCD panel inspection, for example, demands rapid auto-focusing, which plays the key role for the related equipments to obtain highly distinguishable inspection image for rectification. In general, the amplification factor of the object lens used in the TFT-LCD panel inspection process is 2-5 times (2-5×), and the depth of field (DOF) is from 0.5 um to 91 um. Therefore, to achieve auto-focusing is very difficult.

The auto-focusing methods can be categorized as passive focusing and active focusing. The active focusing mainly uses laser triangulation. In other words, a laser spot, a camera and a laser form the triangle. The angle of a charge-coupled device (CCD) in the triangle can be determined by the position of the laser spot in the CCD screen. These conditions determine a triangle and the distance to the target object can be computed. This approach is fast in focusing, but the result of focusing is restricted by the surface characteristics of the target object. For example, the reflection characteristic of a metal surface can affect the focusing effect. On the other hand, the passive focusing method often uses two consecutive images to determine the focus planar position. Although this approach is less demanding on the equipment, the time to focus is longer because a large amount of images data must be processed. Currently, the requirement for repetitive focusing is less than 0.5 second each time. As such, the passive focusing method performs poorly in auto-focusing tracking operation.

The conventional auto-focusing systems are divided into two types. The first type is to utilize the Fourier transform in the filter theory to find the high frequency object in the image and define as a focus evaluation function, and then to search for the maximum focus value in the focus range. The theoretic base is that the focus area shows high frequency characteristics and the focus range is related to horizontal focus area. At present, there is a plurality of ways to define focus evaluation functions, such as, Tenengrad criterion, sum-modified-Laplacian (SML), sum-modulus-difference (SMD), frequency selective weighted median (FSWM) filter, and so on. In addition, quasi condition reasoning search is also applied to defining the focus evaluation function. These known methods all point to the two main factors in auto-focusing: high frequency characteristics and search rule.

The second type of conventional auto-focusing system is to utilize speckle characteristic inspection. By adding a set of laser source to the main optical path and shielding half speckle, a specially designed optical loop reflects the laser beam to a CCD sensor and the off-in-focus position can be determined by the position and the shape of the speckle.

### SUMMARY

The primary object of the present invention is to shorten the focusing time of the microscopic auto-focusing system. Through bevel-axial structure, the present invention disposes the image-capturing CCD at a proper tilt angle to a vertical plane so as to directly determine the optimal in-focus position on the object surface by different in-focus positions.

An embodiment of the present invention discloses a bevel-axial microscopic auto-focusing system, including an optical microscopic system, a charge-coupled device (CCD), an image-capturing card, a controller and a motor driver; wherein the optical microscopic system further including a light source, a first lens, a spectroscope, a second lens and a microscope objective, disposed in sequence from top down for observing an object; the microscope objective being for magnifying an image of the object; the light source emitting light, the emitted light travelling through the first lens, the spectroscope, the second lens and the microscope objective to reach and be reflected by the object; the reflected light travelling through the microscope objective, the second lens and the spectroscope; the reflected light being rotated 90° by the spectroscope and travelling to the CCD disposed laterally to a side of the spectroscope; the CCD being disposed in a bevel-axial manner of forming a tilt angle 0 between the surface of the CCD and a vertical axis; the controller using the image-capturing card to capture a microscopic image of the object through the bevel-axial CCD and controlling the motor driver to drive the microscope objective to provide focusing along the vertical axis to achieve auto-focusing.

Another embodiment of the present invention discloses a bevel-axial microscopic auto-focusing method, including: using a camera to capture a full-frame bevel-axial input image; using an image analysis technique to read information of the captured image and providing resulted grayscale strength information to a statistic analysis module to extract image statistic features, and performing probability function fitting; and performing estimation based on the feature parameters after fitting.

### BRIEF DESCRIPTION OF THE DRAWINGS

FIG. 1 shows a schematic view of the structure of a bevel-axial microscopic auto-focusing system according to an embodiment of the present invention.

FIG. 2 shows a schematic view of the structure of a preferred embodiment of the controller of FIG. 1.

FIG. 3 shows a flowchart of a bevel-axial microscopic auto-focusing method according to an embodiment of the present invention.

FIGS. 4A-4B show an in-focus image and an off-focus image of a LCD panel captured in LCD manufacturing process by CCD using the bevel-axial microscopic auto-focusing method according to an embodiment of the present invention.

FIGS. 5A-5B show an original image and a post Sobel-filter image of the gradient changes in the horizontal direction.

FIGS. 6A-6B show an original image and a corresponding FV curve.

FIG. 7 shows a view of image row data and result of the fitting statistic information.

### DETAILED DESCRIPTION OF THE DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

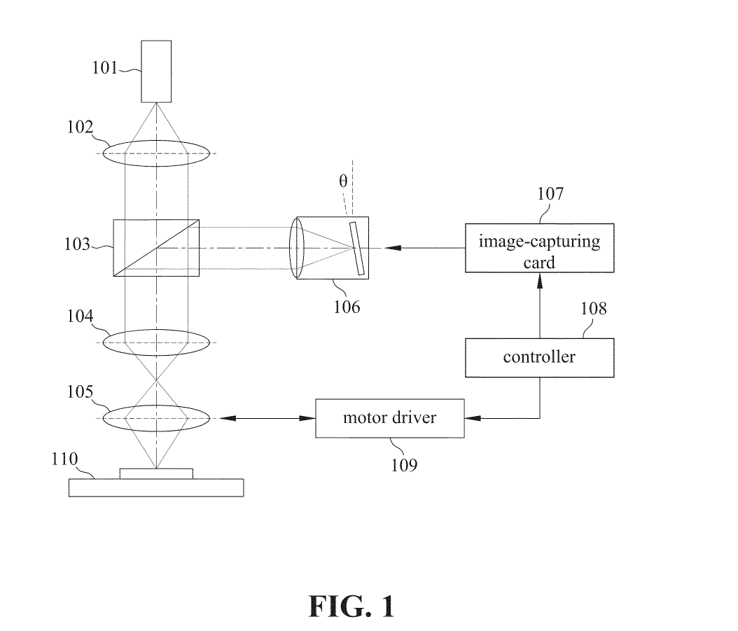

FIG. 1 shows a schematic view of the structure of a bevel-axial microscopic auto-focusing system according to an embodiment of the present invention. As shown in FIG. 1, a bevel-axial microscopic auto-focusing system according to an embodiment of the present invention includes an optical microscopic system, a charge-coupled device (CCD) 106, an image-capturing card 107, a controller 108 and a motor driver 109; wherein the optical microscopic system further including a light source 101, a first lens 102, a spectroscope 103, a second lens 104 and a microscope objective 105, disposed in sequence from top down for observing an object 110; the microscope objective 105 being for magnifying an image of the object 110; the light source 101 emitting light, the emitted light travelling through the first lens 102, the spectroscope 103, the second lens 104 and the microscope objective 105 to reach and be reflected by the object 110; the reflected light travelling through the microscope objective 105, the second lens 104 and the spectroscope 103; the reflected light being rotated 90° by the spectroscope 103 and travelling to the CCD 106 disposed laterally to a side of the spectroscope 103; the CCD 106 being disposed in a bevel-axial manner of forming a tilt angle θ between the surface of the CCD 106 and a vertical axis; the controller 108 using the image-capturing card 107 to capture a microscopic image of the object 110 through the bevel-axial CCD 106 and controlling the motor driver 109 to drive the microscope objective 105 to provide focusing along the vertical axis to achieve auto-focusing.

It should be noted that the CCD 106 is preferably disposed in a manner to form a tilt angle θ between the surface of the CCD 106 and a vertical axis; and the preferred angle range is 10°-45°, such as, 20°. The CCD 106 provides information on different in-focus positions of the source image through the tilt angle θ between the surface and a vertical axis so as to adjust the distance along the vertical axis to determine the optimal in-focus position on the object surface.

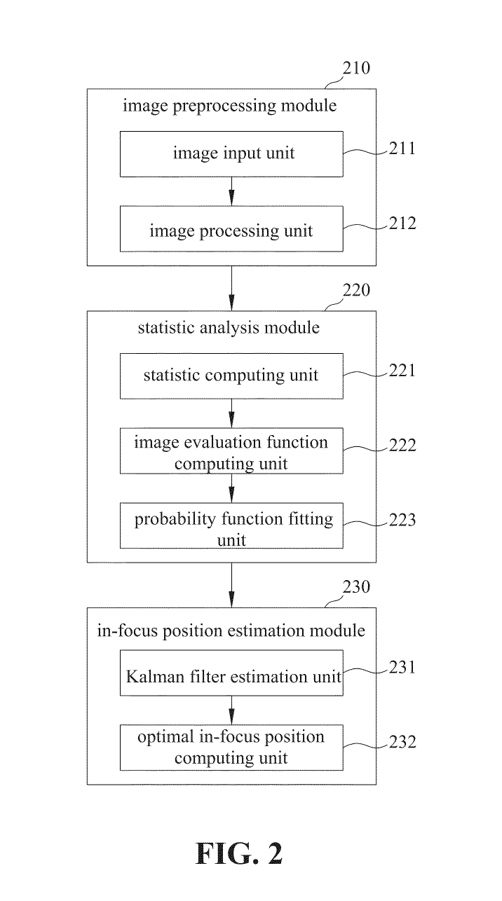

FIG. 2 shows a schematic view of the structure of a preferred embodiment of the controller of FIG. 1. As shown in FIG. 2, the controller 108 further includes: an image preprocessing module 210, a statistic analysis module 220 and an in-focus position estimation module 230. In the instant embodiment, the image preprocessing module 210 further includes an image input unit 211 and an image processing unit 212. The image-capturing default mode of the image input unit 211 is configured according to the characteristics of the object and usage environment; the image processing unit 212 is responsible for extracting image grayscale values within a designated window and obtaining the gradient changes in the image strength in the horizontal direction through a filter. Then, the strip of sampling block is defined for the full-frame image and the image strength of the block is extracted horizontally moving from left to right.

In the instant embodiment, the statistic analysis module 220 further includes a statistic computing unit 221, an image evaluation function computing unit 222 and a probability function fitting unit 223. The statistic computing unit 221 performs statistic computation for the image strength of the blocks extracted in segments, such as, computing the mean, variance and maximum of the strength. Then, the image evaluation function computing unit 222 computes the image evaluation function of each segment block and substitutes the mean, variance and maximum of the strength into a designated image evaluation function, such as, FV=w₁Iₘ+w₂Iₛ+w₃Iₘₐₓ, wherein Iₘ is the statistic mean, Iₛ is the variance, Iₘₐₓ is the maximum, and parameters w₁, w₂, w₃ must be adjusted according to the use. Ideally, the FV curve is a Gaussian probability distribution curve, and the extreme values of the Gaussian curve are the in-focus position (IFP) of the image. Finally, FV curve is normalized and the probability function fitting unit 223 fits the curve.

Similarly, in the instant embodiment, the in-focus position estimation module 230 further includes a Kalman filter estimation unit 231 and an optimal in-focus position computing unit 232. The Kalman filter estimation unit 231 can eliminate the interference on the image characteristics caused by the external noise, and then the extreme positions of the mean ûₘ and variance ûₛ of Gaussian curve obtained in the Gaussian curve fitting are used and the optimal in-focus position computing unit 232 uses actual measurement residual to estimate the optimal in-focus position.

As such, the statistics, such as, the mean uₘ and the variance uₛ of the image evaluation function can be estimated. It should be noted that because the actual image-capturing may include considerable amount of noises, the in-focus position may be shifted. Therefore, the present invention combines the Kalman filter and uses the Gaussian curve fitting residual data res₁, res₂ to estimate ûₘ and ûₛ in-focus position.

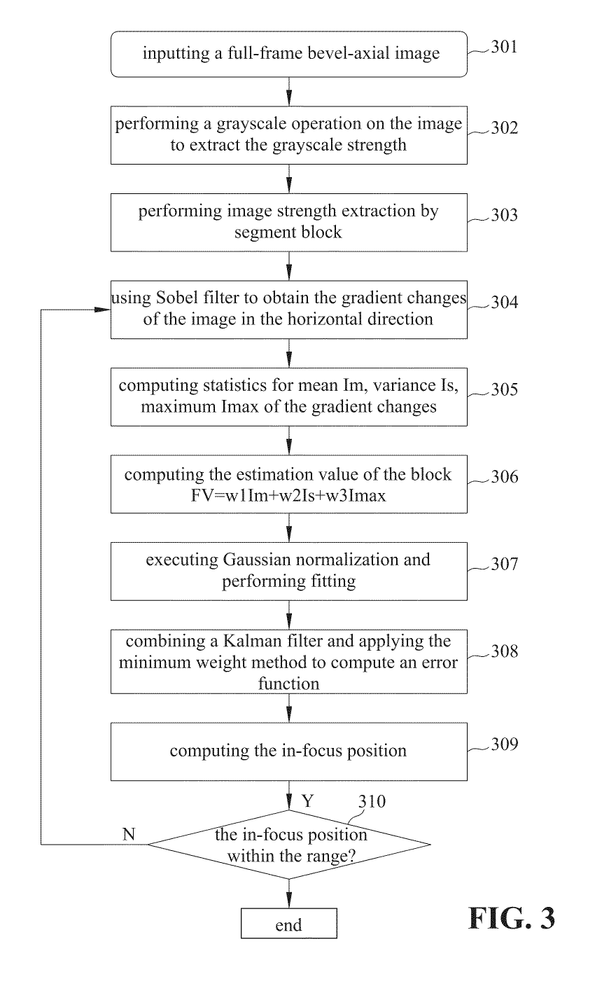

FIG. 3 shows a flowchart of a bevel-axial microscopic auto-focusing method according to an embodiment of the present invention. In reference also to the controller in FIG. 2, as shown in FIG. 3, step 301 is to input a full-frame bevel-axial image; and in step 302, the grayscale operation is performed on the image to extract the grayscale strength. Step 303 is to perform image strength extraction by segment block. Step 304 is to detect inspect image, such as, using Sobel filter to obtain the gradient changes of the image in the horizontal direction. Step 305 is to compute statistics for the mean Iₘ, the variance Iₛ and the maximum Iₘₐₓ of the gradient changes. Step 306 is to compute the estimation value of the block, such as, assigning a weight K1, K2, and K3 respectively to the mean Iₘ, the variance Iₛ and the maximum Iₘₐₓ of the gradient changes in step 305 and computing the sum. Step 307 is to execute Gaussian normalization and perform fitting. Then, step 308 is to combine the Kalman filter and apply the minimum weight method to compute an error function. Step 309 is to compute the in-focus position and determine whether the in-focus position is within the range, as shown in step 310; if not within the range, return to step 301 and repeat the above steps.

The following uses an actual exemplar to describe the intermediate image and related computation in the bevel-axial microscopic auto-focusing method.

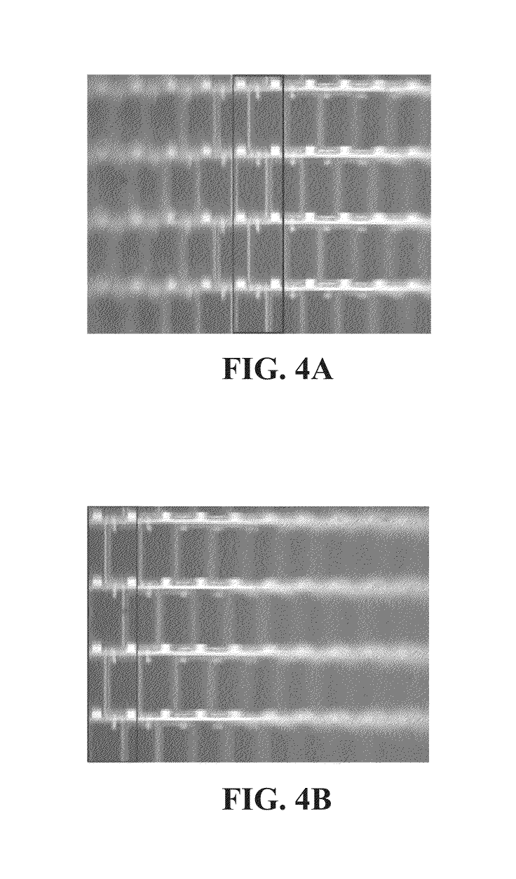

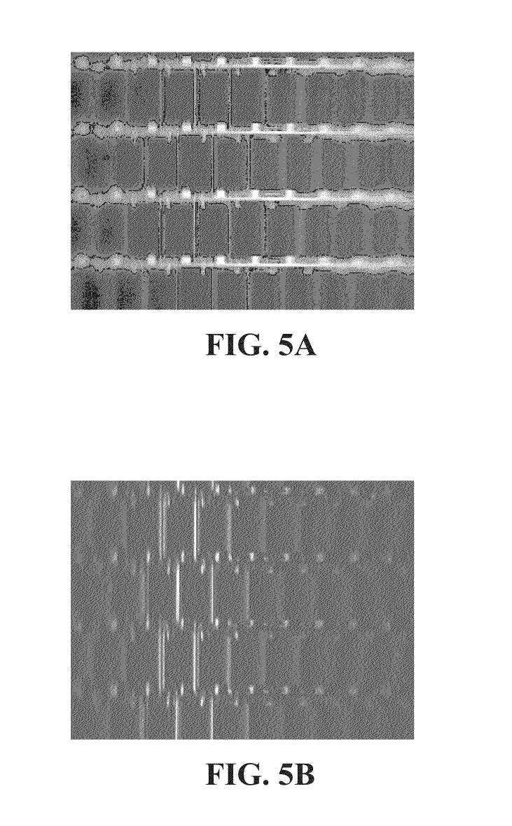

FIG. 4 shows a view of a LCD panel captured in LCD manufacturing process by CCD using the bevel-axial microscopic auto-focusing method according to an embodiment of the present invention, wherein FIG. 4A shows an in focus-image and FIG. 4B shows an off-focus image. The central part of FIG. 4A is the clearest part of the image. If the object moves up or down, the central clear part will move left or right. Therefore, the image must be re-focused. As aforementioned, the focusing area shows the high frequency characteristics and the focusing area range is related to the horizontal focusing area. Hence, a filter, such as, Sobel filter, can be used to obtain the gradient changes in the horizontal direction. FIG. 5 shows the image of the gradient changes, wherein FIG. 5A shows the original image and FIG. 5B shows the image of gradient changes in the horizontal direction after Sobel filter. The Sobel filter shows the following characteristics:

$${I}_{h} = ( \begin{matrix}- 1 & 0 & 1 \\ - 2 & 0 & 2 \\ - 1 & 0 & 1\end{matrix} )$$

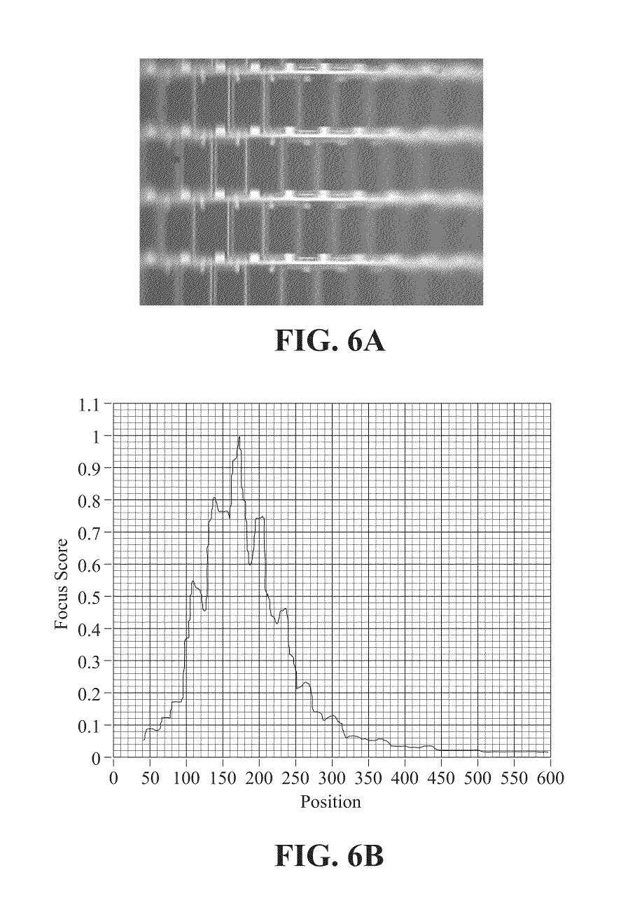

Then, according to the gradient changes in the horizontal direction, the statistics of the aforementioned mean Iₘ, variance Iₛ, maximum Iₘₐₓ of the gradient changes in an image area is computed. For example, an image area can be defined as a block of 80×480 pixels. Then, a proper weight is assigned respectively to the mean Iₘ, variance Iₛ, maximum Iₘₐₓ, and the FV estimation value is computed, such as, FV=0.5Iₘ+0.4Iₛ+0.1Iₘₐₓ. It should be noted that the weights can be used in the weight adjustment parameters of the panel focusing inspection. FIG. 6A shows an original image and FIG. 6B shows a corresponding FV curve. The original image shown in FIG. 6A is the original image when the microscope objective moves −100 um.

In an ideal situation, the curve should be close to the FV curve theoretic values. Therefore, assume the FV is a Gaussian distribution. Based on the assumption, the center of the Gaussian curve is the in-focus position of the image. Therefore, the FV curve is first normalized and then fitting is performed.

Assume that the curve is a Gaussian function:

$$y ( x ) = {e}^{\frac{{( x - u )}^{2}}{2 {σ}^{2}}} \qquad ( 1 )$$

The goal is let the function y(x) and the observed value ŷ(x) have the minimum of δ, where

δ=minΣ[y−ŷ]² (2)

To obtain y(x), the least square method is used to compute the residual u, and e. First, a partial derivation is performed on the equation of u, σ to obtain a matrix Z0 having fᵤ, f_{σ}.

$$\begin{matrix}\begin{matrix}{f}_{u} = \frac{\partial f}{\partial u} = \frac{{e}^{\frac{{( x - u )}^{2}}{2 {σ}^{2}} ( x - u )}}{{e}^{2}} \\ {f}_{σ} = \frac{\partial f}{\partial u} = \frac{{e}^{\frac{{( x - u )}^{2}}{2 {σ}^{2}} {( x - u )}^{2}}}{{e}^{3}}\end{matrix} & ( 3 ) \\ {Z}_{0} = [ \begin{matrix}{f}_{u 1} & {f}_{σ 1} \\ ⋮ & ⋮ \\ {f}_{ui} & {f}_{σ i} \\ ⋮ & ⋮ \\ {f}_{um} & {f}_{σ m}\end{matrix} ] & ( 4 )\end{matrix}$$

Assume that the initial value of u is the center of mass of the image horizontal gradient and σ is the 1-e⁻¹ search block (such as, 50 pixels), a matrix D can be determined as:

$$D = [ \begin{matrix}{y}_{1} - {\hat{y}}_{1} \\ {y}_{2} - {\hat{y}}_{2} \\ ⋮ \\ {y}_{i} - {\hat{y}}_{i}\end{matrix} ] \qquad ( 5 )$$

Modification matrix AA can be determined by equations (4), (5) to obtain the new values for u and σ as ũ and \tilde{σ}:

$$\begin{matrix}{Z}_{i}^{T} {Z}_{i} Δ A = {Z}_{i}^{T} D & ( 6 ) \\ [ \begin{matrix}\tilde{u} \\ \tilde{σ}\end{matrix} ] = [ \begin{matrix}u \\ σ\end{matrix} ] + Δ A & ( 7 )\end{matrix}$$

Repeat computing equations (4)-(7) until modification matrix ΔA is sufficiently small to obtain the closest fitting value y(x), i.e., to obtain the image in-focus position u. The result is shown in FIG. 6B.

As aforementioned, assume that FV curve is a Gaussian distribution and the in-focus position is estimated through Gaussian fitting. Therefore, the mean Iₘ and the variance Iₛ can be computed, and uₘ and uₛ can be obtained through Gaussian curve fitting to estimate the two estimated image in-focus positions:

ûₘ=uₘ, residual res₁ (8)

ûₛ=uₛ, residual res₂ (9)

The present invention must use the relation of ûₘ, ûₛ to obtain the IFP Kalman filter value. In the I of the present invention, ûₘ, ûₛ , are the peak value and the measured value, z ∈ R, and:

z=IIu+w (10)

wherein the system noise is:

$$\begin{matrix}H = [ \begin{matrix}1 \\ 1\end{matrix} ] , u = [ \begin{matrix}{u}_{m} \\ {u}_{s}\end{matrix} ] & ( 11 ) \\ w = [ \begin{matrix}{w}_{1} \\ {w}_{2}\end{matrix} ] = [ \begin{matrix}1 \text{/} {( {res}_{1} )}^{2} \\ 1 \text{/} {( {res}_{1} )}^{2}\end{matrix} ] & ( 12 )\end{matrix}$$

The least square method is then applied to obtain the error function ε:

$$\begin{matrix}ɛ = {( z - H \hat{u} )}^{T} w ( z - H \hat{u} ) \\ = {\sum }_{i = 1}^{2} {{w}_{i} ( \hat{u} - {u}_{i} )}^{2}\end{matrix} \qquad ( 13 )$$

The differential on ε is 0,

$$\frac{\partial ɛ}{\partial \hat{u}} = 2 {\sum }_{i = 1}^{2} {w}_{i} ( \hat{u} - {u}_{i} ) = 0 \qquad ( 14 )$$

As a result, the û is obtained as 0:

$$\hat{u} = \frac{{w}_{1} {u}_{m} + {w}_{2} {u}_{s}}{{w}_{1} + {w}_{2}} \qquad ( 15 )$$

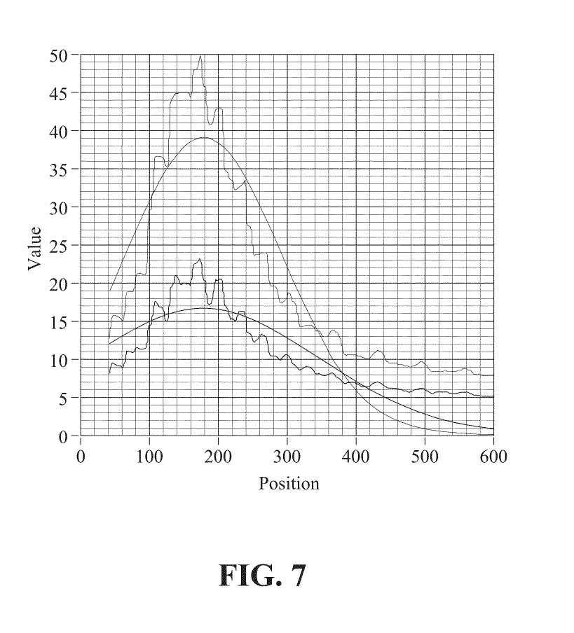

The final result is as shown in FIG. 7. FIG. 7 shows a view of image row data and result of the fitting statistic information.

In summary, the bevel-axial auto-focusing system disclosed in the embodiment of the present invention is a high-performance, high-precision and low-cost auto-focusing system, combining with image analysis, statistic analysis and estimation method as well the software/hardware interface control. The bevel-axial auto-focusing system of the present invention provides the following advantages: (1) using CCD camera as sensor input to avoid image ghosting interference with the captured image caused by the conventional laser speckle; (2) simple in design, directly applicable to existent inspection machines and low in cost compared to conventional speckle-based design; (3) providing full-frame image feature information and complete characteristic analysis; and (4) combining estimation method to increase correct in-focus positioning probability, minimizing image noise interference and more robust. Furthermore, the bevel-axial auto-focusing method of the present invention can further dispose multi-band laser source and introducing co-axial optical path for laser repair, laser welding, or performing fast precise alignment in semiconductor equipment.

An embodiment of the present invention discloses a bevel-axial microscopic auto-focusing system, including an optical microscopic system, a charge-coupled device (CCD), an image-capturing card, a controller and a motor driver; wherein the optical microscopic system further including a light source, a first lens, a spectroscope, a second lens and a microscope objective, disposed in sequence from top down for observing an object; the microscope objective being for magnifying an image of the object; the light source emitting light, the emitted light travelling through the first lens, the spectroscope, the second lens and the microscope objective to reach and be reflected by the object; the reflected light travelling through the microscope objective, the second lens and the spectroscope; the reflected light being rotated 90° by the spectroscope and travelling to the CCD disposed laterally to a side of the spectroscope; the CCD being disposed in a bevel-axial manner of forming a tilt angle θ between the surface of the CCD and a vertical axis; the controller using the image-capturing card to capture a microscopic image of the object through the bevel-axial CCD and controlling the motor driver to drive the microscope objective to provide focusing along the vertical axis to achieve auto-focusing.

Another embodiment of the present invention discloses a bevel-axial microscopic auto-focusing method, including: using a camera to capture a full-frame bevel-axial input image; using an image analysis technique to read information of the captured image and providing resulted grayscale strength information to a statistic analysis module to extract image statistic features, and performing probability function fitting; and performing estimation based on the feature parameters after fitting.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A bevel-axial microscopic auto-focusing system, comprising:
an optical microscopic system, a charge-coupled device (CCD), an image-capturing card, a controller and a motor driver;
wherein the optical microscopic system further including a light source, a first lens, a spectroscope, a second lens and a microscope objective, disposed in sequence from top down for observing an object; the microscope objective being for magnifying an image of the object; the light source emitting light, the emitted light travelling through the first lens, the spectroscope, the second lens and the microscope objective to reach and be reflected by the object; the reflected light travelling through the microscope objective, the second lens and the spectroscope; the reflected light being rotated 90° by the spectroscope and travelling to the CCD disposed laterally to a side of the spectroscope; the CCD being disposed in a bevel-axial manner of forming a tilt angle θ between the surface of the CCD and a vertical axis; the controller using the image-capturing card to capture a microscopic image of the object through the bevel-axial CCD and controlling the motor driver to drive the microscope objective to provide focusing along the vertical axis to achieve auto-focusing.

2. The bevel-axial microscopic auto-focusing system as claimed in claim 1, wherein the tilt angle formed by the surface of the CCD and a vertical axis is preferred within a range of 10°-45°.

3. The bevel-axial microscopic auto-focusing system as claimed in claim 2, wherein the tilt angle formed by the surface of the CCD and a vertical axis is preferably 20°.

4. The bevel-axial microscopic auto-focusing system as claimed in claim 1, wherein the controller further comprises: an image preprocessing module, a statistic analysis module and an in-focus position estimation module; wherein
the image preprocessing module further configuring image-capturing default mode according to characteristics of the object and usage environment; responsible for extracting image grayscale values within a designated window and obtaining the gradient changes in the image strength in the horizontal direction through a filter, defining a strip of sampling block for the full-frame image and extracting the image strength of the block horizontally moving from left to right;
the statistic analysis module performing the statistic computation of mean and variance and maximum for the image strength of the blocks extracted in segments; computing the image evaluation function of each segment block and substituting the mean, variance and maximum of the strength into a designated image evaluation function (FV); normalizing FV curve and obtaining a fitting curve;
the in-focus position estimation module eliminating the interference on the image characteristics caused by the external noise, and then the extreme positions of the mean and variance of Gaussian curve obtained in the Gaussian curve fitting and using actual measurement residual to estimate the optimal in-focus position.

5. The bevel-axial microscopic auto-focusing system as claimed in claim 4, wherein the image preprocessing module further comprises an image input unit and an image processing unit; wherein the image input unit configures the image-capturing default mode according to the characteristics of the object and usage environment; the image processing unit is responsible for extracting image grayscale values within a designated window and obtaining the gradient changes in the image strength in the horizontal direction through a filter; and defines a strip of sampling block for the full-frame image and extracts the image strength of the block horizontally moving from left to right.

6. The bevel-axial microscopic auto-focusing system as claimed in claim 4, wherein the statistic analysis module further comprises a statistic computing unit, an image evaluation function computing unit and a probability function fitting unit;
wherein the statistic computing unit performs performing the statistic computation of mean and variance and maximum for the image strength of the blocks extracted in segments; the image evaluation function computing unit computes the image evaluation function of each segment block and substituting the mean, variance and maximum of the strength into a designated image evaluation function (FV); and the probability function fitting unit fits the curve.

7. The bevel-axial microscopic auto-focusing system as claimed in claim 4, wherein the in-focus position estimation module further comprises a Kalman filter estimation unit and an optimal in-focus position computing unit;
wherein the Kalman filter estimation unit eliminates the interference on the image characteristics caused by the external noise, and then the extreme positions of the mean and variance of Gaussian curve obtained in the Gaussian curve fitting are used; and the optimal in-focus position computing unit 232 uses actual measurement residual to estimate the optimal in-focus position.

8. A bevel-axial microscopic auto-focusing method, comprising:
inputting a full-frame bevel-axial image;
performing a grayscale operation on the image to extract the grayscale strength;
performing image strength extraction by segment block;
using Sobel filter to obtain the gradient changes of the image in the horizontal direction;
computing statistics for the mean, the variance and the maximum of the gradient changes;
computing the estimation value of the block;
executing Gaussian normalization and performing fitting;
combining a Kalman filter and applying the minimum weight method to compute an error function; and
computing the in-focus position and determine whether the in-focus position being within the range; if not within the range, repeating all the above steps.
